(19) United States
(12) Patent Application Publication
(10) Pub. No.: US 2010/0020052 A1
(43) Pub. Date: Jan. 28, 2010

(54) METHOD OF CONTROLLING DISPLAY CHARACTERISTIC AND DISPLAY APPARATUS USING THE SAME

(76) Inventor: Ju Seon Kim, Gyeongsangbuk-do (KR)

Correspondence Address: KED & ASSOCIATES, LLP, P.O. Box 221200, Chantilly, VA, 20153-1200, US

(21) Appl. No.: 12/526,682

(22) PCT Filed: Nov. 5, 2007
(86) PCT No.: PCT/KR2007/005552

§ 371 Date: Aug. 11, 2009

(30) Foreign Application Priority Data
Jul. 26, 2007 (KR) 10-2007-0074953

(51) Int. Cl. G06F 3/038

(52) U.S. Cl. 345/207

(57) ABSTRACT

A display characteristic control method provides an on-screen display (OSD) of display characteristics values automatically controlled according to ambient illuminance levels, to enable user recognition and confirmation of current values. A display apparatus adopting the method includes a display module for displaying a video signal; an illuminance sensor for detecting a level of ambient illuminance; a system controller for adjusting, based on the detected ambient illuminance, at least one display characteristic of the display module and for generating a set of control values corresponding to the adjusted at least one display characteristic; a display characteristic controller for controlling the display module using the adjusted at least one display characteristic; and an OSD generator for generating OSD data for display on a display screen together with the video signal, the displayed OSD data corresponding to the display characteristic control values of the adjusted at least one display characteristic.

### TECHNICAL FIELD

The present invention relates to displays, and more particularly, to a method of controlling a display characteristic of a display apparatus and a display apparatus using the same.

### BACKGROUND ART

In a contemporary display apparatus such as a television receiver, a set of external controls such as keys or dials is typically provided on a remote control device or on the television receiver itself as a user interface device for manually setting corresponding display characteristics of a screen of the television receiver. Such a user interface device provides the user with means to adjust as desired a variety of display characteristics, for example, contrast, brightness, color density, tint, sharpness, and backlight. In other words, a user manually controls a display characteristic of a contemporary television receiver by manipulating the corresponding external control.

These display characteristics are subjective parameters best set according to user preferences, but they are particularly affected by the current ambient conditions in the vicinity of the screen with respect to the television receiver's installation site. That is, the ambient conditions directly affect the display characteristics, and the most significant ambient condition is luminous intensity, which can be measured as luminous flux (lux) incident on a unit area, where one lux (lx) of illuminance equals one lumen per square meter (lm/m²).

For example, in cases where the level (intensity) of ambient illuminance is high or low, a brightness display characteristic of a screen should be set accordingly. Other display characteristics are likewise manually adjusted according to user preference, such that performance of an individual adjustment of each display characteristic is necessary for varying ambient luminosities, which inconveniences the user. At the same time, the status of the settings of such display characteristic may be unknown to the user at any given time, further encumbering accurate adjustments.

### DISCLOSURE OF INVENTION

Accordingly, the present invention is directed to a display characteristic control method and a display apparatus using the same that substantially obviates one or more of the problems due to limitations and disadvantages of the related art.

An object of the present invention is to provide a method of controlling a display characteristic of a display apparatus and a display apparatus using the same, by which the display characteristic of the display apparatus (e.g., a television receiver) can be automatically controlled and adjusted according to ambient illuminance levels using a digital scheme.

Another object of the present invention is to provide a method of controlling a display characteristic of a display apparatus and a display apparatus using the same, by which primary display characteristics are automatically controlled according to ambient illuminance levels and by which a secondary (final) display characteristic can be correspondingly adjusted manually according to user preference using a user interface device.

Another object of the present invention is to provide a method of controlling a display characteristic of a display apparatus and a display apparatus using the same, by which values of specifically controlled display characteristics are displayed to enable user recognition and confirmation of current values.

Additional features and advantages of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the present invention, as embodied and broadly described, there is provided a method of controlling display characteristics in a video apparatus. The method comprises steps of displaying a video signal on a display screen; detecting a level of ambient illuminance with respect to the display screen; adjusting, based on the detected ambient illuminance, at least one display characteristic of the display screen and for generating a set of control values corresponding to the adjusted at least one display characteristic; controlling a display of the video signal using the adjusted at least one display characteristic; and generating on-screen display (OSD) data for display on the display screen together with the video signal, the displayed OSD data corresponding to the display characteristic control values of the adjusted at least one display characteristic.

According to another aspect of the present invention, there is provided another method of controlling display characteristics in a video apparatus. This method comprises steps of displaying a video signal on a display screen; detecting an ambient illuminance with respect to the display screen, the detected ambient illuminance corresponding to one of a plurality of primary display grades for controlling at least one display characteristic of the display screen; determining, based on the detected ambient illuminance, the primary display grade corresponding to the detected ambient illuminance, for determining a plurality of secondary display grades with respect to the determined primary display grade, and for generating a set of control values corresponding to at least one of the determined primary grade and a final display grade of the at least one display characteristic set according to a user selection from among the plurality of secondary display grades; controlling a display of the video signal using the generated set of display characteristic control values; and generating on-screen display (OSD) data for display on the display screen together with the video signal, the displayed OSD data corresponding to the plurality of secondary display grades

According to another aspect of the present invention, there is provided a display apparatus suitable for executing either of the above methods.

It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate embodiment(s) of the invention and together with the description serve to explain the principles of the invention. In the drawings:

FIG. 1 is a block diagram of a display apparatus according to the present invention;

FIGS. 2A and 2B are diagrams of exemplary user interface menus for executing a digital eye function according to the method of the present invention, to determine a specific display grade in a video mode, where FIG. 2B illustrates a user interface menu generated as an on-screen display appearing on a screen responsive to activation of a hot key for executing a digital eye function according to the method of the present invention;

FIG. 3 is a graph of ambient luminosities versus display characteristic control values arranged according to a plurality of display grades, illustrating a hysteresis of a digital eye function according to the method of the present invention;

FIG. 4 is a flowchart illustrating the concept of the present invention, including a determination of the primary display grade only;

FIGS. 5A and 5B are diagrams of exemplary OSD data generated according to display characteristics, which may be displayed on a screen in an Eye-Q video mode together with a corresponding video signal;

FIG. 6 is a flowchart of a display characteristic control method according to one embodiment of the present invention;

FIG. 7 is a flowchart of a display characteristic control method according to another embodiment of the present invention; and

FIG. 8 is a flowchart of a process for displaying OSD data according to the present invention.

### BEST MODE FOR CARRYING OUT THE INVENTION

A television receiver or display device adopting the present invention includes a “digital eye” function enabling digital control to adjust a display characteristic based on detected ambient conditions, namely, illuminance levels. Thus, the present invention employs a digital eye method including steps of measuring ambient illuminance by detecting a level of illuminance measured externally with respect to a display screen, generating an analog value corresponding to the measured ambient illuminance, converting the analog value into a digital value, and appropriately adjusting (controlling) based on the digital value at least one display characteristic of the display device, e.g., a television receiver.

According to the present invention, a display apparatus uses a digital eye function as above to measure ambient illuminance and convert the measurement value into a digital value. Then, display characteristics of the display apparatus are automatically and appropriately controlled according to the digital value. A further selection, i.e., a manual control of a user interface, allows the automatically controlled display characteristics to be more precisely controlled by a user desiring such control. The controlled display characteristics are updated and displayed on a screen in real time, or periodically, to enable the user to recognize and confirm the display characteristic control by viewing a set of control (adjustment) values of the display characteristics, which are displayed as on-screen display (OSD) data. The display characteristics may include one or more of a contrast value, a brightness value, a color density value, a sharpness value, and a backlight value. Among these, the adjusted value for brightness or backlight is in general inversely proportional to the detected level of the ambient illuminance, and the adjusted value for contrast, color density, or sharpness is in general directly proportional to the detected level of the ambient illuminance. When a predetermined increment or decrement in luminosity is detected with respect to a boundary value existing between adjacent grades, a current primary display grade changes to a next-higher or next-lower grade.

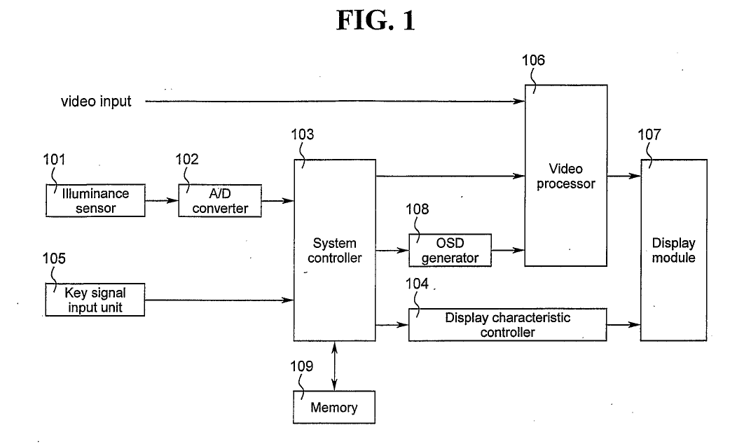

Referring to FIG. 1, a display apparatus such as a television receiver according to the present invention includes an illuminance sensor 101 for detecting (measuring) an ambient illuminance with respect to the television receiver; an analog-to-digital (A/D) converter 102 for converting the detected ambient illuminance into a digital value corresponding to one of a predetermined number of digital values, for example, 64 digital values; a system controller 103 for determining a primary display grade setting at least one display characteristic of a screen according to the digital value and for determining a final display grade based on a selected one of a plurality of secondary display grades corresponding to the determined primary display grade; a display characteristic controller 104 for outputting, to a display module under control of the system controller, a display characteristic control signal based on primary and secondary grade values corresponding to the determined grades per display characteristic, that is, a set of values which may differ for each display characteristic; a key signal input unit 105 as a user interface device for inputting a command signal to the system controller according to user selections; a video processor 106; a display module 107; an on-screen display (OSD) generator 108 for generating OSD data according to the present invention, including OSD corresponding to the secondary display grades, to enable a user interface for a user selection via the key signal input unit of a secondary display grade and thereby determine a final display grade; and a memory 109 for storing a set of the primary and secondary grade values per display characteristic. Accordingly, the display characteristic controller 104 receives display characteristic control values (adjustment values) corresponding to the final display grade and outputs a corresponding display characteristic control signal to control at least one display characteristic, namely, one or more of a contrast, a brightness, a color density, a sharpness, and backlight of an image, i.e., a selectively input video signal, to be displayed on a display screen of the display module 107. In general, the display characteristic control values corresponding to the primary and secondary display grades are set to be proportional to the detected level of ambient illuminance in the case of a contrast, color density, or sharpness value and are set to be inversely proportional to the detected level of ambient illuminance in the case of a brightness or backlight value.

The video processor 106 may be a composite video signal processor, i.e., a processor including audio circuitry for providing a speaker output, and typically receives at least one composite video input signal that has been selectively (e.g., according to a user selection) applied from a signal source such as analog and/or digital tuner or peripheral input, to produce a displayable signal including an audible component, which may comprise a picture-in-picture or multi-picture display of plural broadcast signals. In the present invention, the video processor 106 processes at least one selected composite video signal, i.e., a video input, to output a video signal to the display module 107, for example, a flat-panel display device such as a PDP or LCD module, and may output an audio signal to a speaker (not shown).

The display module 107 also displays OSD data in accordance with an output of the display characteristic controller 104. The OSD data is generated by the OSD generator 108 to be processed by the video processor 106 and is displayed together with the processed video signal on a display screen of the display module 107. In doing so, under control of the system controller 103, the OSD generator 108 generates OSD data for display characteristic control values corresponding to the primary display grade determined by an image quality algorithm stored in the memory 109 and may further generate OSD data for display characteristics corresponding to the final grade. The thus generated OSD data is provided to the video processor 106, which processes the OSD data to be displayable and outputs the processed data to the display module 107. Accordingly, in the event that a user provides a necessary command signal via the key signal input unit 105, the OSD generator 108 provides OSD data corresponding to the secondary grades for display via the display screen, thereby enabling the user to select one of the secondary grades as a final grade. In this case, if the user fails to make such a selection within a prescribed time, the primary grade as determined by the image quality algorithm may be used as a final grade.

A display apparatus according to the present invention measures an ambient illuminance using the illuminance sensor 101, to convert the measured analog illuminance value into a digital value using the analog-to-digital converter 102, which receives from the illuminance sensor a sampled signal at a rate of about 20 ms and generates one of a predetermined number of digital values according to the measured ambient illuminance. The digital value output of the analog-to-digital converter 102 to the system controller 103 may be achieved as an average over a period of about 500 ms. A manufacturer of the display apparatus may, using a test measurement of ambient luminosities, assign a plurality of grades (digital value ranges) to the predetermined number of digital values, say, 64 values, to classify the digital values according to grade. Here, the entire range of available digital values is evenly distributed over the plurality of grades; in this case, five grades, i.e., first to fifth grades, are assigned. A display characteristic of the screen is then adjusted by the system controller 103 according to a corresponding grade.

In more detail, in generating a digital value according to a detection of the intensity of the ambient illuminance, a speed provided to the analog/digital converter 102, i.e., a sub-microcomputer, from the illuminance sensor 101 is about 20 ms, with one of 64 digital values to be output according to the measured ambient illuminance. Meanwhile, a speed for providing the digital value to the system controller 103 from the analog/digital converter 102 takes about 500 ms. Therefore, a television receiver manufacturer may sort the 64 digital values into a plurality of grades according to test measurements. The system controller 103, i.e., a main microcomputer, automatically adjusts display characteristics of the screen according to the respective grades.

Table 1 includes an exemplary set of display characteristic control values, which are stored in the memory 109 with respect to digital ambient illuminance values and arranged according to grade for each of five display characteristics. Though absent from the following table, control values (adjustment values) for a backlight display characteristic may be similarly stored in the memory 109. Values of Table 1 may be defined by a manufacturer.

TABLE 1

| ambient | primary | secondary | | | | | |
|---|---|---|---|---|---|---|---|
| illuminance | grade | grade | | brightness | color | | |
| (lm/m²) | values | value | contrast | (Y bias) | density | tint | sharpness |
| over 150 lx | 48~63 | +3 | 106% | 76 (−15) | 70 | 0 | 70 |
| | (1st grade) | +2 | 104% | 66 (−35) | 70 | 0 | 70 |
| | | +1 | 102% | 56 (−55) | 70 | 0 | 70 |
| | | 0 | 100% | 40 (−75) | 70 | 0 | 70 |
| | | −1 | 85% | 37 (−85) | 70 | 0 | 70 |
| | | −2 | 70% | 33 (−95) | 70 | 0 | 70 |
| | | −3 | 55% | 30 (−105) | 70 | 0 | 70 |
| 118~150 lx | 36~47 | +3 | 105% | 88 (−11) | 60 | 0 | 60 |
| | (2nd grade) | +2 | 103% | 68 (−31) | 60 | 0 | 60 |
| | | +1 | 101% | 58 (−51) | 60 | 0 | 60 |
| | | 0 | 95% | 45 (−71) | 60 | 0 | 60 |
| | | −1 | 80% | 38 (−81) | 60 | 0 | 60 |
| | | −2 | 65% | 35 (−91) | 60 | 0 | 60 |
| | | −3 | 50% | 32 (−101) | 60 | 0 | 60 |
| 84~118 lx | 24~35 | +3 | 104% | 80 (−07) | 50 | 0 | 50 |
| | (3rd grade) | +2 | 102% | 70 (−27) | 50 | 0 | 50 |
| | | +1 | 100% | 60 (−47) | 50 | 0 | 50 |
| | | 0 | 90% | 50 (−67) | 50 | 0 | 50 |
| | | −1 | 75% | 39 (−77) | 50 | 0 | 50 |
| | | −2 | 60% | 36 (−87) | 50 | 0 | 50 |
| | | −3 | 45% | 33 (−97) | 50 | 0 | 50 |
| 50~84 lx | 12~23 | +3 | 102% | 85 (−03) | 45 | 0 | 45 |
| | (4th grade) | +2 | 97% | 75 (−17) | 45 | 0 | 45 |
| | | +1 | 90% | 65 (−37) | 45 | 0 | 45 |
| | | 0 | 80% | 55 (−57) | 45 | 0 | 45 |
| | | −1 | 67% | 47 (−67) | 45 | 0 | 45 |
| | | −2 | 53% | 43 (−77) | 45 | 0 | 45 |
| | | −3 | 40% | 36 (−87) | 45 | 0 | 45 |
| under 50 lx | 0~11 | +3 | 100% | 90 (+13) | 40 | 0 | 40 |
| | (5th grade) | +2 | 90% | 80 (−07) | 40 | 0 | 40 |
| | | +1 | 80% | 70 (−27) | 40 | 0 | 40 |
| | | 0 | 70% | 60 (−47) | 40 | 0 | 40 |
| | | −1 | 57% | 55 (−57) | 40 | 0 | 40 |
| | | −2 | 46% | 50 (−67) | 40 | 0 | 40 |
| | | −3 | 35% | 39 (−77) | 40 | 0 | 40 |

As can be seen from Table 1, ambient illuminance may be classified into one of five primary display grades, namely, a first, second, third, fourth, or fifth grade, corresponding to a range of primary grade values determined according to a detected level of illuminance that is measured externally with respect to a front or forwardly disposed part of the display module 107, and a plurality of secondary grade values are allotted to each of the five primary display grades. The resulting display characteristic may be determined with respect to each of a contrast, brightness, color, tint, sharpness, and backlight, where each of the respective display characteristic control values of Table 1 are based on the detected luminosities as well as the corresponding grades. In the exemplar of Table 1, the tint display characteristic is nominally set at zero regardless of values determined for the primary and secondary display grades; the color and sharpness display characteristics are typically equal and generally remain constant throughout any given grade, that is, with no adjustment made according to secondary grade value.

The number designations of the primary display grades are inversely proportional to the detected level of ambient illuminance. Also, corresponding display characteristic control values for contrast, color density, or sharpness are in general set to values proportional to ambient illuminance, while the brightness or backlight control value is in general set to a value inversely proportional to ambient illuminance.

Accordingly, if the level of ambient illuminance is over 150 lx (i.e., ≧150 lx or not less than 150 lx), a display characteristic is classified as a first grade in which the output of the analog-to-digital converter 102 has a value range of 48˜63. If ambient illuminance is 118˜150 lx, a display characteristic is classified as a second grade in which the output of the analog-to-digital converter 102 has a value range of 36˜47. If ambient illuminance is 84˜118 lx, a display characteristic is classified as a third grade in which the output of the analog-to-digital converter 102 has a value range of 24˜35. If ambient illuminance is 50˜84 lx, a display characteristic is classified as a fourth grade in which the output of the analog-to-digital converter 102 has a value range of 12˜23. If the level of ambient illuminance is under 50 lx (i.e., ≦50 lx or not greater than 50 lx), a display characteristic is classified as a fifth grade in which the output of the analog-to-digital converter 102 has a value range of 0˜11. Assuming a secondary grade value of zero for each of the above five grades, that is, before (or without) determining a secondary grade value, the first-grade settings for contrast, brightness, color density, and sharpness are 100%, 40 (−75), 70, and 70, respectively; the second-grade settings for contrast, brightness, color density, and sharpness are 95%, 45 (−71), 60, and 60, respectively; the third-grade settings for contrast, brightness, color density, and sharpness are 90%, 50 (−67), 50, and 50, respectively; the fourth-grade settings for contrast, brightness, color density, and sharpness are 80%, 55 (−57), 45, and 45, respectively; and the fifth-grade settings for contrast, brightness, color density, and sharpness are 70%, 60 (−47), 40, and 40, respectively. A further display characteristic may include a video value selected according to a manufacturer-defined or user-defined set of characteristics, for example, a “sharp” video value (e.g., a nominal first-grade value), a “comfort” video value (e.g., a nominal third-grade value), or a “smooth” video value (e.g., a nominal fifth-grade value), any one of which may be set as part of a default condition.

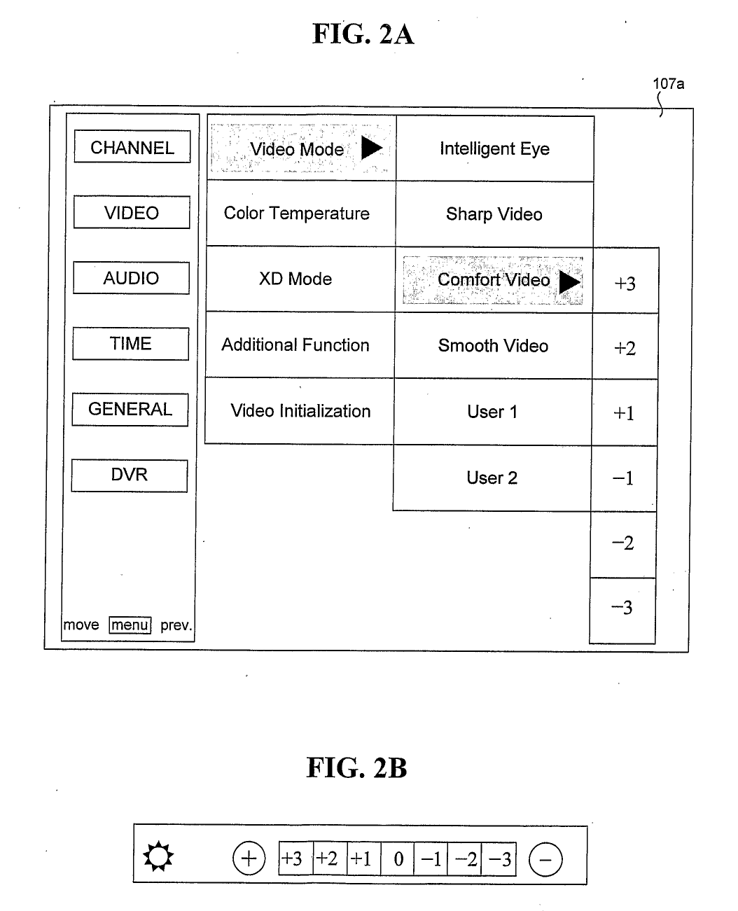

According to the display characteristic control method as described above, when it is determined that there has been a change in the digital value such that a boundary value of a current primary display grade is passed by a predetermined value (boundary value+/−α), the current primary display grade is changed to the next-higher or lower-grade. In particular, in response to a determination by the system controller 103 that an analog ambient illuminance value as detected by the illuminance sensor 101 is newly input to the analog-to-digital converter 102, thereby determining that an updated digital ambient illuminance value is available, the system controller determines based on the currently supplied digital value which of the preset first to fifth display grades is to be set initially on the screen. The system controller 103 thus determines the corresponding grade as a primary display grade and generates via the display characteristic controller 104 a corresponding set of display characteristic control values as shown in Table 1. The system controller 103 controls the OSD generator 108 to display an OSD menu (user interface menu) such as that shown in FIG. 2A or 2B, so that a secondary or final display grade may be determined according to a user selection.

Referring to FIG. 2A, by operating the key signal input unit 105, a plurality of menu icons such as “channel,” “video,” “audio,” “time,” “general,” and “DVR” may be displayed on a display screen 107a of the display module 107. With a subsequent operation of the key signal input unit 105, for example, by activating the above video menu icon, a set of mode menu items (e.g., video mode, color temperature, XD mode, additional function, and video initialization) corresponding to the above video menu item may be displayed. Thus, a video mode may be entered by another subsequent operation of the key signal input unit 105, for example, by pressing the above video menu item followed by a pressing of the video mode menu item for the digital eye (intelligent eye or “Eye-Q”) function, to thereby generate of a set of sub-menu items including, for example, sharp video, comfort video, smooth video, user 1, and user 2. In doing so, one of the sub-menu items may be highlighted (e.g., the “comfort mode” in FIG. 2A), indicating that a primary display grade is set by default or according the primary display grade determination. Optionally, as shown in FIG. 2B, activation of a hot key for selecting the final display grade results in an on-screen display of a plurality of secondary display grades corresponding to a determined primary display grade. In other words, the highlighted sub-menu item or hot-key selection corresponds to the determined primary display grade, namely, one of the first through fifth grades.

The above “sharp,” “comfort,” and “smooth” video settings each include a set of display characteristic values stored in the memory 109 according to Table 1 and may correspond to the first, third, and fifth grades, respectively. Meanwhile, display characteristic values of either of user 1 and user 2 may be assigned to a predetermined set of display characteristics, as in Table 1, to reflect a preferred set of display characteristics stored in the memory 109 according to user preferences. For instance, if the primary display grade is determined as the comfort video setting, e.g., the third grade, the highlighted sub-menu item is “comfort” video” and a corresponding set of secondary grade values are displayed, i.e., +3, +2, +1, 0, −1, −2, and −3. Thereafter, one of these values may be selected to determine the secondary display grade and thus the final display grade. For instance, if the user selects a +3 secondary grade value per the third grade, i.e., the comfort video mode, the system controller 103 generates via the display characteristic controller 104 an appropriate set of display characteristic control values, i.e., a contrast control value of 104%, a brightness control value of 80 (−07), a color density control value of 50, a tint control value of 0, and a sharpness control value of 50, and applies the above display characteristic control values to the display module 107, which thus provides a controlled screen having the display characteristics according to the user selection.

In one embodiment, each of the primary display grades may be provided with six “sub-grades” as secondary display grades, where, for the corresponding display characteristic control value of a given primary grade, a number (e.g., three) of sub-grade values are respectively set as increasingly greater control values and where a like number of sub-grade values are respectively set as increasingly lower control values. Here, the secondary display grades may be more effectively applied for the contrast and brightness (or backlight) control values only, since the respective color density, tint, and sharpness control values are typically set as constants for a given primary grade.

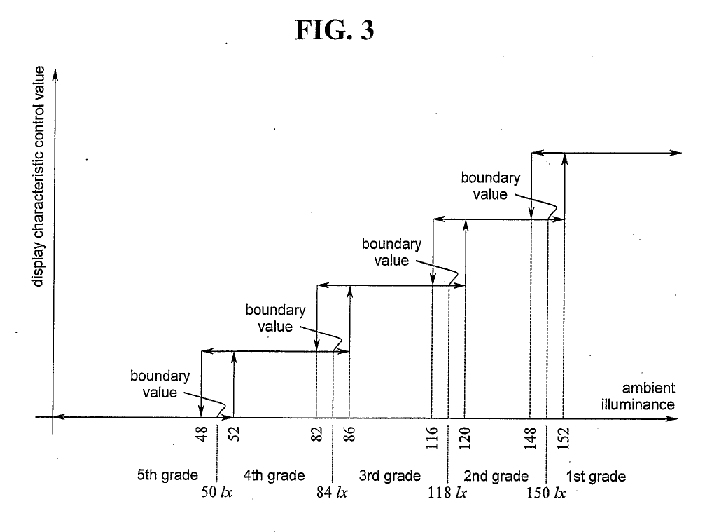

FIG. 3 demonstrates the determination of a primary display grade according to ambient illuminance level, including a hysteresis effect for implementing a digital eye function to prevent a flickering phenomenon from appearing on the screen, which may occur as a result of frequent changes in the display characteristic control value according to minute variations in ambient conditions. Here, although a current primary display grade changes to a next-higher or next-lower grade when a predetermined increment or decrement in luminosity is detected with respect to a boundary value existing between adjacent grades, flickering is prevented by the ensuing hysteresis effect. For instance, assuming that a current display characteristic grade is the second grade and that a boundary value between the second and first grades is 150 lx, if the digital value of the ambient illuminance surpasses a value of 152 (or 150+2), the system enters the first grade; that is, the current display characteristic grade changes from the second grade to the first grade. Subsequently, if the digital value drops below 148 (or 150−2), the current display characteristic grade changes from the first grade to the second grade such that the system enters the second grade.

That is, even after the final grade has been determined once, the system controller 103 continues to periodically find a converted digital value of the ambient illuminance. Subsequently, when each of the periodically found digital values is added/subtracted by a predetermined value greater than an ambient illuminance intensity boundary value of a current primary grade, i.e., a boundary value +α or a boundary value −α, the current primary grade is shifted to a next-higher or -lower grade with respect to the current primary grade.

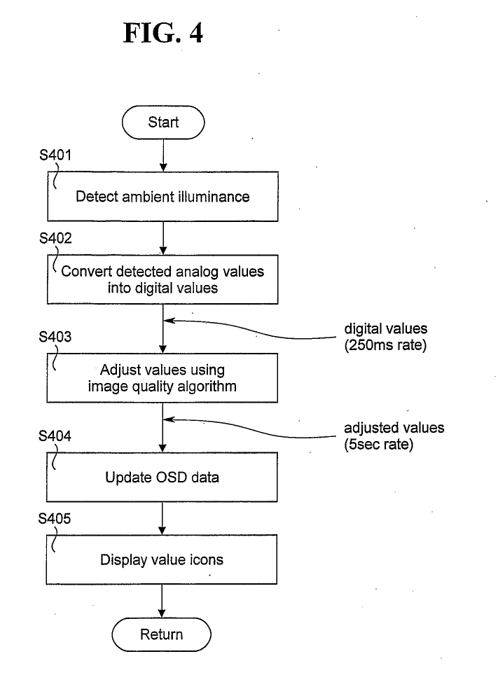

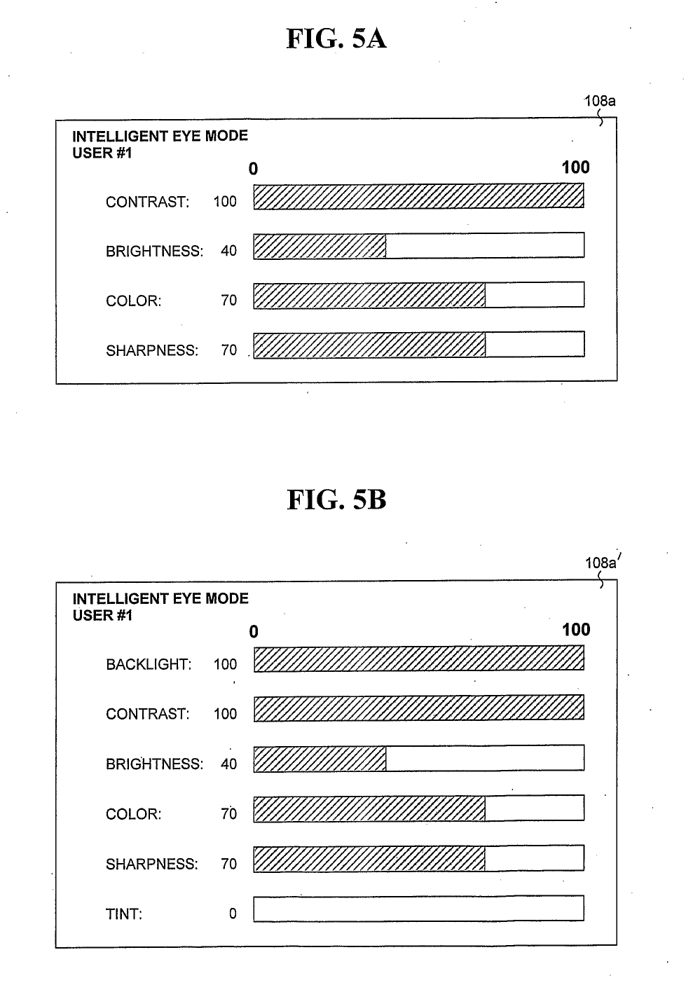

FIG. 4 illustrates a concept of the present invention in which updated value icons, indicative of the adjusted values for display characteristics, are displayed using OSD data. First, ambient illuminance intensity with respect to a display apparatus adopting the present invention is detected by the illuminance sensor 101, which is preferably installed on a forward-facing surface of the display apparatus, for example, adjacent an upper or lower corner of a display screen (S401). The illuminance sensor 101, such as a photosensor, outputs an analog signal representative of the level of the intensity of the detected ambient illuminance. Thereafter, under control of the system controller 103, a digitized value of the ambient illuminance intensity is generated by the A/D converter 102, i.e., a sub-microcomputer, using an averaged output or by sampling at a rate of, for example, about 250 ms, depending on the stability of the photosensor output (S402). According to an image quality algorithm, the digitized values are used to adjust (control) specific display characteristics of the display apparatus, such as the contrast or brightness values, thereby generating adjusted values (S403). OSD data corresponding to adjusted values may be periodically updated at a predetermined data rate of, say, a few seconds or more (S404). Although slower rates may be applied, a data rate of five seconds may be preferred by a user, and faster rates may be employed so that the resulting OSD display appears more in real time to the user. Finally, as in FIG. 5A or 5B, the updated OSD data values are output by the display apparatus using an on-screen display of graphical icons representative of the status of adjusted values of display characteristics (S405). Typically, the OSD data is superposed on the displayed video signal output, and the values of display characteristics—adjusted according to the currently detected intensity of ambient illumination in real time—are displayed on the display screen together with other image information.

Here, it should be appreciated that any number of display characteristics may be included in OSD data 108a (or 108a′) and that other combinations may be achieved by the OSD generator 108 according to user-specific selections provided to the key input signal unit 105 or default system settings. Specific display characteristics may be displayed, singly or in combination, on a screen in an Eye-Q video mode. Thus, the system controller 103 determines primary display grade setting values of each of a specific set of display characteristic of a screen and determines a final display grade of the display characteristics based on a secondary display grade selection corresponding to the determined primary display grade.

It should be further appreciated that, according to the above concept of the present invention, the display characteristics may be adjusted by a determination of the primary display grade only. Yet a similar display of updated value icons may be achieved based on values adjusted according secondary or “final” display grade settings as well.

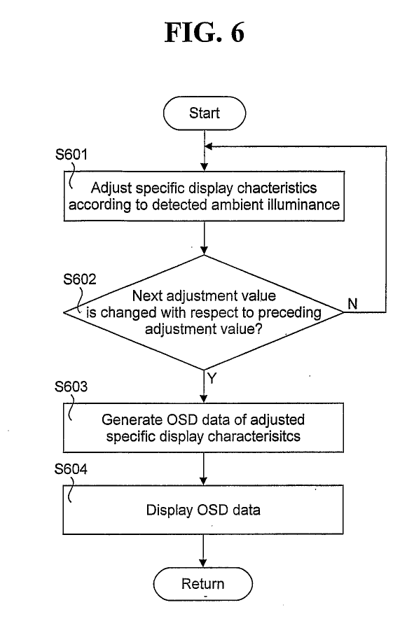

FIG. 6 illustrates a display characteristic control method according to one embodiment of the present invention, which employs a “digital eye” video mode of a display apparatus. That is, when the video mode of a display apparatus adopting the present invention is set to a digital eye mode, the intensity of the ambient illuminance is periodically detected using a photosensor or similar device, whereby digital values representative of the corresponding detection are generated. Subsequently, according to the present invention, display characteristics are determined, and then adjusted accordingly, based on the detected ambient illuminance (S601). If a value comparison determines that a next control value is changed with respect to a preceding control value, the OSD generator 108 generates OSD data corresponding to values for adjusting the display characteristics, i.e., the control values of the step S601, and the generated OSD data values are displayed by the display module 107 (S602, S603, S604). Hence, a user is able to recognize and confirm instantaneous statuses of the adjusted display characteristics.

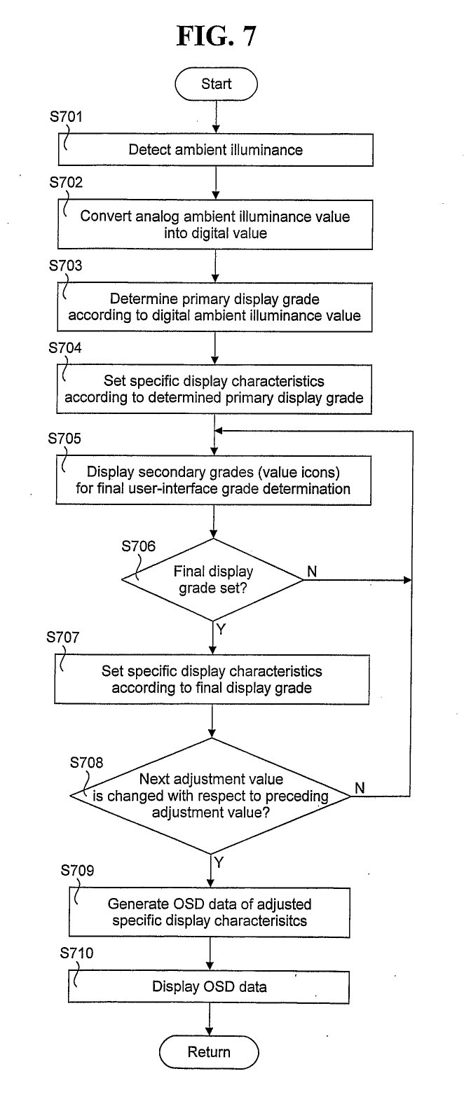

FIG. 7 illustrates a display characteristic control method according to another embodiment of the present invention, which also employs a “digital eye” video mode of a display apparatus. Here, in a digital eye mode, the illuminance sensor 101 detects the intensity of the ambient illuminance periodically and outputs a corresponding analog value (S701). The detected ambient illuminance value is converted to a digital value under control of the system controller 103 (S702). A primary display grade is automatically determined according to the digitized ambient illuminance value (S703). Display characteristics are then primarily determined (set) according to the determined primary display grade (S704). Subsequently, a plurality of secondary grades belonging to the determined primary display grade may be displayed as value icons, e.g., indications of secondary control values of +3, +2, +1, −1, −2, and −3, to enable (allow) a user to manually select a final display grade using the key signal input unit 105 (S705). It is then determined which one of the plurality of secondary display grades may have been selected as a final display grade by the user (S706). If a final display grade is selected, for example, within a prescribed time limit, the displayed display characteristics are adjusted (set) according to the selected final display grade (S707). It is then determined, based on a comparison step, whether there is a difference between a preceding display grade value (current adjustment value) and the newly adjusted final grade value, i.e., a next adjustment value (S708). If so, corresponding OSD data of the finally adjusted display characteristics is generated (S709) and the generated OSD data is displayed accordingly (S710).

Hence, the user is able to recognize values of the finally adjusted display characteristics and is further enabled to recognize a value of each preferred display characteristic according to the currently detected ambient illuminance. That is, according to the present invention, once a primary display grade is determined to automatically adjust the display characteristics, the secondary display grade determination as performed by a user interface may be carried out by referencing OSD information displayed on the screen.

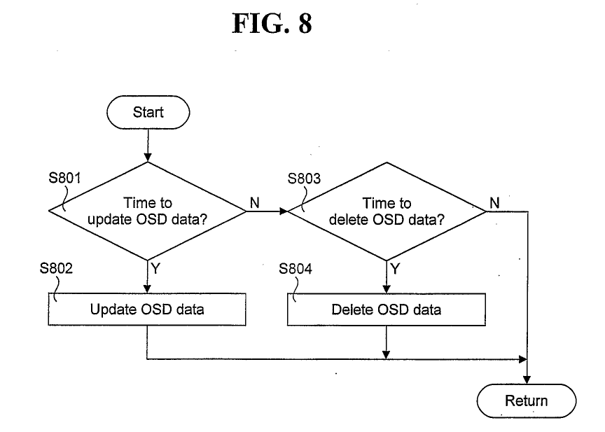

FIG. 8 illustrates a process for displaying OSD data according to the present invention, as in the step S604 or S710. Here, it is first determined whether it is time to update the OSD data, as in the step S602 or S708, whereupon, the system controller 103 updates the current OSD data, namely, the displayed OSD data (S801, S802). Meanwhile, it is determined whether it is time to delete (i.e., dump) the current OSD data, as in the case of terminating an OSD function or exiting a digital eye mode, whereupon the system controller 103 deletes the currently displayed OSD data such that only the video signal is displayed (S803, S804).

Accordingly, when a video mode of a video apparatus such as a television receiver is set to a digital eye mode of the present invention, for example, an intelligent eye (or “Eye-Q”) mode, the present invention controls characteristics of a display screen by first determining, under control of the system controller 103, whether there is a digital ambient illuminance value input from the analog/digital converter 102 based on an analog level input from the illuminance sensor 101. The digital value is periodically correlated to one of a plurality of primary display grades, and the system controller 103 uses an image quality algorithm to determine the corresponding display grade as the primary display grade, to provide a corresponding set of display characteristic control values (as in Table 1) to the display module 107 via the display characteristic controller 104. At the same time, the system controller 103 may control the OSD generator 108 for displaying an OSD picture, i.e., a user interface displayed on the screen as in FIG. 2A or 2B, so that a secondary (or final) display grade may be determined according to a user selection. Thus, the user is able to finally set up a specific display grade by readjusting the primarily adjusted display characteristics manually. That is, the display characteristics can be automatically adjusted (controlled) by the algorithm and then manually and finally adjusted (set) by the user. Therefore, the above Eye-Q mode enables the user to recognize values of the display characteristics corresponding to the primarily adjusted display grade and confirm values of the display characteristics corresponding to the finally adjusted display grade. In particular, while the display grade is changed by the algorithm according to an ambient illuminance detection by the illuminance sensor 101 or similar device, OSD data is generated periodically or in real time using the corresponding display characteristics. The generated OSD data is then displayed on the screen. The OSD data may be generated and displayed at the time of determining the primary display grade and at the time of determining the final display grade or may be generated and displayed at the time of determining either the primary display grade or the final display grade.

Embodiments of the present invention include a computer-readable medium storing a set of program commands for executing operations implemented by a computer. The computer-readable medium may include the program commands, a data file, a data structure, and other computer-program-related data. The medium and the stored program commands are configured in accordance with the present invention and may be specifically designed for the above-described embodiment or may comprise a device and program combination known to those skilled in the field of computer software.

### INDUSTRIAL APPLICABILITY

Accordingly, by utilizing an on-screen display of a display apparatus such a television receiver, the present invention enables a user to recognize and confirm any of a set of current values for specific display characteristics, in real time or periodically, as the display characteristics are controlled according to ambient illuminance levels. Meanwhile, an automatic adjustment of a display characteristic avoids the inconvenience in manually adjusting one or more display characteristics. Since parameters of a plurality of display characteristics may be effectively ganged together, the inconvenience of individually controlling each display characteristic is likewise avoided. In addition, reduced power consumption may be achieved by measuring ambient illuminance to enable an appropriate adjustment of a display characteristic according to continuously changing ambient conditions. Employment of a digital method provides an enhanced display characteristic of a screen to a user and more precisely adjusted user-specific values.

While the present invention has been described and illustrated herein with reference to one or more preferred embodiments, it will be apparent to those skilled in the art that various modifications can be made in the present invention without departing from the spirit or scope of the invention. Thus, it is intended that the present invention covers such modifications provided they come within the scope of the appended claims and their equivalents.

What is claimed is:

1. A display apparatus, comprising:
a display module for displaying a video signal;
an illuminance sensor for detecting a level of ambient illuminance with respect to said display module;
a system controller for adjusting, based on the detected ambient illuminance, at least one display characteristic of said display module and for generating a set of control values corresponding to the adjusted at least one display characteristic;
a display characteristic controller for controlling said display module using the adjusted at least one display characteristic; and
an on-screen display (OSD) generator for generating OSD data for display on a display screen of said display module together with the video signal, the displayed OSD data corresponding to the display characteristic control values of the adjusted at least one display characteristic.

2. The display apparatus of claim 1, wherein the at least one display characteristic includes at least one of a contrast, a brightness, a color density, a sharpness, and a backlight.

3. The display apparatus of claim 2, wherein the contrast, color density, and sharpness display characteristics have display characteristic control values set in proportion to the level of detected ambient illuminance and wherein the brightness and backlight display characteristics have display characteristic control values set in inverse proportion to the level of detected ambient illuminance.

4. A display apparatus, comprising:
a display module for displaying a video signal;
an illuminance sensor for detecting an ambient illuminance with respect to said display module, the detected ambient illuminance corresponding to one of a plurality of primary display grades for controlling at least one display characteristic of said display module;
a system controller for determining, based on the detected ambient illuminance, the primary display grade corresponding to the detected ambient illuminance, for determining a plurality of secondary display grades with respect to the determined primary display grade, and for generating a set of control values corresponding to at least one of the determined primary grade and a final display grade of the at least one display characteristic set according to a user selection from among the plurality of secondary display grades;
a display characteristic controller for controlling said display module using the generated set of display characteristic control values; and
an on-screen display (OSD) generator for generating OSD data for display on a display screen of said display module together with the video signal, the displayed OSD data corresponding to the plurality of secondary display grades.

5. The display apparatus of claim 4, wherein the displayed OSD data includes OSD data corresponding to the final display grade control values.

6. The display apparatus of claim 4, wherein the final display grade control values are updated periodically and wherein the displayed OSD data includes OSD data for the updated final control values.

7. The display apparatus of claim 6, wherein said system controller determines whether a difference exists between a current control value of the adjusted at least one display characteristic and a preceding control value of the corresponding display characteristic and wherein the OSD data corresponding to the display characteristic control values of the adjusted at least one display characteristic is generated only if a difference is determined to exist.

8. The display apparatus of claim 4, wherein the at least one display characteristic of said display module is adjusted by adding to the secondary display grade control values to the primary display grade control values.

9. The display apparatus of claim 8, wherein the displayed OSD data includes OSD data corresponding to the display characteristic control values of the adjusted at least one display characteristic.

10. The display apparatus of claim 4, wherein said illuminance sensor outputs an analog ambient illuminance value based on the detected ambient illuminance.

11. The display apparatus of claim 10, further comprising:
an analog-to-digital converter for converting the detected ambient illuminance into a digital value,
wherein the adjusted at least one display characteristic is based on the digital value.

12. The display apparatus of claim 11, wherein the digital value is generated by sampling the analog ambient illuminance value and wherein the determined primary display grade is a current primary display grade that is changed to one of a next-higher primary display grade and a next-lower primary display grade, if a boundary value between the current primary display grade and an adjacent primary display grade is passed by a predetermined value of the generated digital value.

13. The display apparatus of claim 4, further comprising:
a user interface for selecting one of the plurality of secondary display grades with respect to the determined primary display grade, the selected secondary display grade controlling the at least one display characteristic of the display module,
wherein the secondary display grade determination, as executed by said user interface, is carried out by referencing the OSD data displayed on the display screen

14. The display apparatus of claim 4, wherein the plurality of primary display grades is sorted into a predetermined number of grades according to ambient illuminance and wherein the plurality of secondary display grades are sorted into a predetermined number of grades including at least one grade above the corresponding primary display grade and at least one grade below the corresponding primary display grade.

15. A method of controlling display characteristics in a video apparatus, the method comprising:
displaying a video signal on a display screen;
detecting a level of ambient illuminance with respect to the display screen;
adjusting, based on the detected ambient illuminance, at least one display characteristic of the display screen and for generating a set of control values corresponding to the adjusted at least one display characteristic;
controlling a display of the video signal using the adjusted at least one display characteristic; and
generating on-screen display (OSD) data for display on the display screen together with the video signal, the displayed OSD data corresponding to the display characteristic control values of the adjusted at least one display characteristic.

16. The method of claim 15, wherein the at least one display characteristic includes at least one of a contrast, a brightness, a color density, a sharpness, and a backlight.

17. The method of claim 16, wherein the contrast, color density, and sharpness display characteristics have display characteristic control values set in proportion to the level of detected ambient illuminance and wherein the brightness and backlight display characteristics have display characteristic control values set in inverse proportion to the level of detected ambient illuminance.

18. A method of controlling display characteristics in a video apparatus, the method comprising:
displaying a video signal on a display screen;
detecting an ambient illuminance with respect to the display screen, the detected ambient illuminance corresponding to one of a plurality of primary display grades for controlling at least one display characteristic of the display screen;
determining, based on the detected ambient illuminance, the primary display grade corresponding to the detected ambient illuminance, for determining a plurality of secondary display grades with respect to the determined primary display grade, and for generating a set of control values corresponding to at least one of the determined primary grade and a final display grade of the at least one display characteristic set according to a user selection from among the plurality of secondary display grades;
controlling a display of the video signal using the generated set of display characteristic control values; and
generating on-screen display (OSD) data for display on the display screen together with the video signal, the displayed OSD data corresponding to the plurality of secondary display grades.

19. The method of claim 18, wherein the displayed OSD data includes OSD data corresponding to the final display grade control values.

20. The method of claim 18, wherein the final display grade control values are updated periodically and wherein the displayed OSD data includes OSD data for the updated final control values.

21. The method of claim 20, further comprising:
determining whether a difference exists between a current control value of the adjusted at least one display characteristic and a preceding control value of the corresponding display characteristic,
wherein the OSD data corresponding to the display characteristic control values of the adjusted at least one display characteristic is generated only if a difference is determined to exist.

22. The method of claim 18, wherein the at least one display characteristic of the display screen is adjusted by adding to the secondary display grade control values to the primary display grade control values.

23. The method of claim 22, wherein the displayed OSD data includes OSD data corresponding to the display characteristic control values of the adjusted at least one display characteristic.

24. The method of claim 18, wherein the ambient illuminance is detected as an analog ambient illuminance value based on the detected ambient illuminance.

25. The method of claim 24, further comprising:
converting the detected ambient illuminance into a digital value,
wherein the adjusted at least one display characteristic is based on the digital value.

26. The method of claim 25, wherein the digital value is generated by sampling the analog ambient illuminance value and wherein the determined primary display grade is a current primary display grade that is changed to one of a next-higher primary display grade and a next-lower primary display grade, if a boundary value between the current primary display grade and an adjacent primary display grade is passed by a predetermined value of the generated digital value.

27. The method of claim 18, further comprising:
selecting one of the plurality of secondary display grades with respect to the determined primary display grade, the selected secondary display grade controlling the at least one display characteristic of the display module,
wherein the secondary display grade determination, as executed by said selecting, is carried out by referencing the OSD data displayed on the display screen.

28. The method of claim 18, wherein the plurality of primary display grades is sorted into a predetermined number of grades according to ambient illuminance and wherein the plurality of secondary display grades are sorted into a predetermined number of grades including at least one grade above the corresponding primary display grade and at least one grade below the corresponding primary display grade.
